(19) United States
(12) Patent Application Publication
(10) Pub. No.: US 2009/0073439 A1
(43) Pub. Date: Mar. 19, 2009

(54) APPARATUS, COMPUTER-ACCESSIBLE MEDIUM AND METHOD FOR MEASURING CHEMICAL AND/OR MOLECULAR COMPOSITIONS OF CORONARY ATHEROSCLEROTIC PLAQUES IN ANATOMICAL STRUCTURES

(75) Inventors: Guillermo J. Tearney, Cambridge, MA (US); Brett E. Bouma, Quincy, MA (US); Jason T. Motz, Cambridge, MA (US); Joseph A. Gardecki, Acton, MA (US); Alexandra H. Chau, Somerville, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 12/210,979

(22) Filed: Sep. 15, 2008

Related U.S. Application Data
(60) Provisional application No. 60/972,751, filed on Sep. 15, 2007.
(60) Provisional application No. 61/035,248, filed on Mar. 10, 2008.

(51) Int. Cl. G01N 21/00; G02B 6/06; G06G 7/48

(52) U.S. Cl. 356/337; 385/119; 703/12

(57) ABSTRACT

Exemplary apparatus and method can be provided for controlling at least one electro-magnetic radiation. For example, it is possible to rotate and/or translate at least one optical waveguide. At least one of the optical waveguide(s) can receive a first radiation at a first wavelength and transmit the first radiation to at least one sample. Such optical waveguide and/or another optical waveguide may receive a second radiation at a second wavelength that is different from the first wavelength. For example, the second radiation may be produced based on an inelastic scattering of the first radiation. In addition, exemplary apparatus and method can be provided which can also be used to receive data associated with the second radiation, determine at least one characteristic of the at least one sample based on the data, and generate the image and/or the map of a portion of the arterial sample based on the at least one characteristic. Further, exemplary computer-accessible medium can be provided which includes a software arrangement thereon. When a processing arrangement executes the software arrangement, the processing arrangement is configured to modify at least one characteristic of an arrangement using certain procedures. These exemplary procedures include simulating at least one electro-magnetic radiation provided into and out of the arrangement, simulating an inelastic scattering radiation from at least one simulated sample, receiving the simulated inelastic scattering radiation into and out of the simulated arrangement, and determining a simulated characteristic of the simulated arrangement as a function of the simulated inelastic scattering radiation.

### CROSS-REFERENCE TO RELATED APPLICATION(S)

The present invention relates to U.S. Provisional Application No. 60/972,751 filed Sep. 15, 2007 and U.S. Provisional Application No. 61/035,248 filed Mar. 10, 2008, the entire disclosure of which is incorporated herein by reference.

### FIELD OF THE INVENTION

The present invention relates to apparatus, computer-accessible medium and method for measuring the chemical and/or molecular composition of coronary atherosclerotic plaques in living human patients.

### BACKGROUND INFORMATION

The public health significance of coronary artery disease may be very important since cardiovascular disease has been the number one cause of death in the United States for a significant period of time. Given the magnitude of the disease, limited knowledge about the link between human coronary lesions and thrombosis can be a result of the anatomical location of coronary arteries, which may make them difficult to study, and the absence of practical animal models that are truly representative of human disease. As a result, there has been a large amount of interest and effort to develop tools for investigating human coronary arteries in vivo. A number of different imaging technologies that can provide microstructural information such as IVUS and OFDI have been pursued for this purpose for a number of years.

One of the important issues for decreasing the mortality of this disease is an improved understanding of the chemical and molecular basis of human coronary plaque formation, progression, and propensity to cause acute coronary syndromes. The ability to measure chemicals and molecules in human coronary arteries may address these areas as well as lead to better understanding of the response to pharmacological therapy.

While several optical techniques have been shown to identify lipid rich regions, there are many different types of lipid-rich lesions, including xanthomas, lipid-pools, pathologic intimal thickening, and necrotic cores. Of exemplary techniques, e.g., only necrotic cores are generally associated with plaque rupture and acute myocardial infarction. It is believed that no known technique to date has demonstrated the capability to specifically detect necrotic cores. Certain studies have shown that a key chemical signature of necrotic cores is an elevated ratio of free cholesterol to cholesterol ester (F/E). Furthermore, an elevated F/E ratio can be commonly found in necrotic core plaques that have ruptured. A measurement of this ratio may provide a more specific marker for coronary thrombosis risk, as well as a more specific measure of necrotic core fibroatheromas, which would greatly enhance the ability to understand the clinical significance and natural history of these lesions.

Raman spectroscopy is a spectroscopic technique that can be utilized to identify and quantify a large spectrum of biochemicals present in arterial lesions with a high degree of specificity. The potential of Raman spectroscopy for characterizing atherosclerosis has been reviewed using free space laser beam delivery to and collection of the scattered light from the tissue samples ex vivo. Intracoronary Raman spectroscopy is a technology for investigating coronary plaques on the biochemical level, in which a deeper understanding of CAD can be gained. However, conducting the Raman spectroscopy in coronary arteries in living human patients may need the use of optical fiber probes to guide light to and from the coronary lesion. Recent advances in laser sources, detection technologies, catheter designs and signal processing techniques make intracoronary Raman possible. Indeed, Raman spectra may be obtained from a single measurement location in the coronary arteries of living swine. Furthermore, precise control of the orientation of the measurement location can be utilized to locate the lesion for further intervention. To advance the understanding of coronary atherosclerosis and to provide a basis for assessing individual risk for acute myocardial infarction, a detailed chemical Raman map of the coronary plaque can be used.

These and other objects, features and advantages of the present invention will become apparent upon reading the following detailed description of embodiments of the invention, when taken in conjunction with the appended claims.

### OBJECTS AND SUMMARY OF EXEMPLARY EMBODIMENTS OF THE INVENTION

One of the objectives of the exemplary embodiments of the present invention is to overcome certain deficiencies and shortcomings of the conventional point-sampling intracoronary Raman-based systems and methods, and provide exemplary embodiments of systems and methods for obtaining intracoronary scans and associated biochemical-based maps of atherosclerotic lesions using Raman spectroscopy in living human patients.

For example, according to certain exemplary embodiments of the present invention, it is possible to scan arterial tissues and luminal-based organs to provide biochemical maps. One such exemplary embodiment utilizes a pullback mechanism associated with a Raman catheter to provide longitudinal scans along the arterial wall. Such exemplary embodiment can be utilized for line scanning with a single point illumination catheter, and/or to provide mapping of a portion of or the entire artery by using a basket-style contact catheter which simultaneously samples multiple sites of the arterial circumference. Another exemplary embodiment can implement a rotation of the catheter to provide circumferential scanning of a single point measurement Raman catheter. According to yet another exemplary embodiment of the present invention, it is possible to combine the pullback and rotational aspects while utilizing a single-point measurement catheter to provide a continuous helical scan of the arterial wall. For non-contact style catheters, it may be advantageous to include an exemplary saline purge method and apparatus to clear blood from the field and increase the signal-to-noise ratio by reducing absorption and scattering from the blood.

A proper data analysis can be for being able to extract data from the complex Raman spectra that is obtained from biological tissue. In a preferred embodiment, this includes preprocessing of the data to account for system responses such as quantum efficiency of the detector and spectrally dependent optical losses throughout the entire system. Spectral wavenumber or wavelength calibration is also necessary for proper data analysis, especially when physical models employing techniques such as ordinary least squares fitting are utilized. Preferred embodiments may use physical models based on purified chemicals or spectra from morphological components in order to provide data reduction and facilitate meaningful interpretation of the data and enhanced diagnostics which may be accomplished by techniques such as logistic regression, neural networks, or wavelet methods. In one preferred embodiment we utilize the ratio of free to esterified cholesterols to identify necrotic core atheromas.

Thus, exemplary apparatus and method can be provided for controlling at least one electro-magnetic radiation. For example, it is possible to rotate and/or translate at least one optical waveguide. At least one of the optical waveguide(s) can receive a first radiation at a first wavelength and transmit the first radiation to at least one sample. Such optical waveguide and/or another optical waveguide may receive a second radiation at a second wavelength that is different from the first wavelength. For example, the second radiation may be produced based on an inelastic scattering of the first radiation.

It is also possible to receive data associated with the second radiation, and determine at least one characteristic of the sample based on the data. At least one image and/or at least one map of at least one portion of the sample can be generated based on the characteristic(s). Such characteristic(s) can be a chemical characteristic. The image and/or the map can include a ratio of different chemical characteristics. The waveguide(s) can include at least one fiber. The fiber(s) may include a plurality of fibers or a fiber bundle. For example, one of the fibers can receives the first radiation, and another one of the fibers may receive the second radiation. A particular fiber of the fibers can receive the first and second radiations.

According to another exemplary embodiment of the present invention, a spectral separating arrangement may be provided which can be configured to transmit the first radiation to the waveguide(s), and reflect the second radiation. The spectral separating arrangement may be a spatial filter, a dichroic mirror, a grating and/or a prism. Further, the spectral separating arrangement can reflect the first radiation to the waveguide(s), and transmit the second radiation. In still another exemplary embodiment of the present invention, exemplary apparatus and method can be provided which can also be used to receive data associated with the second radiation, determine at least one characteristic of the at least one sample based on the data, and generate the image and/or the map of a portion of the arterial sample based on the at least one characteristic. For example, the arterial sample can be in-vivo.

According to a further exemplary embodiment of the present invention, exemplary computer-accessible medium can be provided which includes a software arrangement thereon. When a processing arrangement executes the software arrangement, the processing arrangement is configured to modify at least one characteristic of an arrangement using certain procedures. These exemplary procedures include simulating at least one electro-magnetic radiation provided into and out of the arrangement, simulating an inelastic scattering radiation from at least one simulated sample, receiving the simulated inelastic scattering radiation into and out of the simulated arrangement, and determining a simulated characteristic of the simulated arrangement as a function of the simulated inelastic scattering radiation.

For example, the simulation of the inelastic scattering radiation can be performed using a Monte-Carlo technique and/or a ray-tracing procedure. In addition, the simulation of the electro-magnetic radiation may be performed using a Monte-Carlo technique and/or a ray-tracing procedure. The simulated arrangement can be a catheter. The simulated sample may be an anatomical structure and/or a fluid. The anatomical structure can be an artery, and the fluid may be blood or a transparent fluid. The processing arrangement may be further configured to modify the simulated arrangement so as to change the characteristic. Further, the processing arrangement can be further configured to compare the simulated characteristic with an actual characteristic of an actual arrangement, and determine a further characteristic of an actual sample based on the comparison. The comparison can be performed using a least squared minimization technique.

Other features and advantages of the present invention will become apparent upon reading the following detailed description of embodiments of the invention, when taken in conjunction with the appended claims.

### BRIEF DESCRIPTION OF THE DRAWINGS

Further objects, features and advantages of the present invention will become apparent from the following detailed description taken in conjunction with the accompanying Figures showing illustrative embodiments of the present invention in which:

FIG. 1 is block diagram of an exemplary embodiment of a system according to the present invention which provides a clinical Raman line mapping with linear pullback;

FIG. 2 is block diagram of an exemplary embodiment of a system according to the present invention which provides a clinical Raman line mapping with circumferential scanning;

FIG. 3 is block diagram of an exemplary embodiment of a circumferential scanning device according to the present invention which includes a rotary junction;

FIG. 4 is block diagram of an exemplary embodiment of a system according to present invention providing a clinical Raman line mapping with linear pullback and circumferential scanning;

FIG. 5 is an exemplary graph of an exemplary normalized Raman signal intensity obtained from a cadaver coronary plaque through a prototype catheter versus the distance through whole swine blood;

FIG. 6 is a flow diagram of an exemplary embodiment of a method used to obtain and process scanned Raman data sets in accordance with the present invention;

FIG. 7A is an exemplary image of a Raman mapped human aorta;

FIG. 7B is an exemplary graph of Raman spectra corresponding to the aorta shown in FIG. 7A;

FIG. 8 is a block diagram of an exemplary embodiment of a system according to the present invention which includes a bench-top Raman mapping system for ex vivo coronary lesions;

FIG. 9A is a schematic illustration of an exemplary simulation geometry according to the present invention;

FIG. 9B is a graph of an exemplary result of a simulated sampling volume for an exemplary Raman probe shown in FIG. 9A;

FIG. 10A is a first exemplary histology image and corresponding exemplary graph of calculated ratiometric quantity of free cholesterol to cholesterol ester versus spatial position; and

FIG. 10B is a second exemplary histology image and corresponding exemplary graph of calculated ratiometric quantity of free cholesterol to cholesterol ester versus spatial position.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention.

### DETAILED DESCRIPTION OF EXEMPLARY EMBODIMENTS

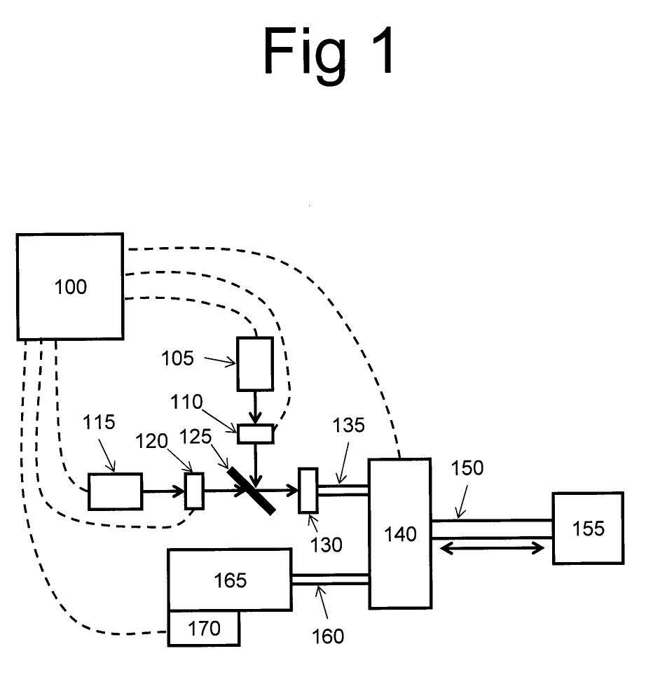

FIG. 1 shows an exemplary embodiment of a measurement system/device according to the present invention which can include two narrow bandwidth diode laser sources 105,115, linear pullback device 140, intracoronary Raman catheter 150, spectrometer 165 and charge coupled device CCD 170. In one exemplary embodiment, the entire Raman spectrum (e.g., 0-3300 cm⁻¹) can be acquired serially with two different narrow bandwidth lasers operating at 740 nm and 830 nm. A use of two lasers can facilitate a collection of both the fingerprint Raman spectral region (e.g., 0-1800 cm⁻¹) and high wavenumber Raman spectral region (e.g., 1800-3300 cm⁻¹) at a high spectral resolution on a single fixed wavelength spectrograph 165. A serial excitation can be accomplished, e.g., by controlling the laser sources 105, 115 with high speed mechanical respective shutters 110, 120.

An excitation light passes through a dichroic mirror 125, and may be coupled (via coupling optics 130) to a delivery channel 135, which can be a fiber or free space. Light may be delivered to a linear pullback device 140 and into the Raman catheter 150, which can be interrogating the tissue 155. The light re-emitted from the tissue lesion is collected by the catheter and passed through the pullback device and into the return light delivery channel 160, which may be fiber or free space and may include coupling optics to couple into the spectrograph 165. The exemplary spectrograph 165 can have a spectral range covering wavelengths between 830 nm and 950 nm with a spectral resolution of at least 8 cm⁻¹. Raman-scattered light can be dispersed and its spectrum may be recorded by the CCD 170. An exemplary embodiment of the CCD can be a thermoelectrically-cooled, deep-depleted, back-illuminated device for, e.g., the highest signal to noise performance. In a particular exemplary embodiment, a pullback device 140 can facilitate a linear retraction of the Raman catheter optics with or without the movement of the outer sheath. A computer 100 may be used to synchronize the mechanical shutters, linear retraction of the pullback device and spectral acquisition by the CCD 170.

A catheter that can possibly provide a satisfactory result utilizing a linear pullback devices can include a basket-type catheter with multiple (e.g., four or eight) prongs that may be mechanically configured to maintain contact with the artery wall. For this exemplary design, each individual prong can contain Raman optics, which may obtain longitudinal spectral maps along each arterial segment as the catheter is pulled back. With contact designs, an attenuation due to blood may be minimized, and the catheter-console interface can be simpler.

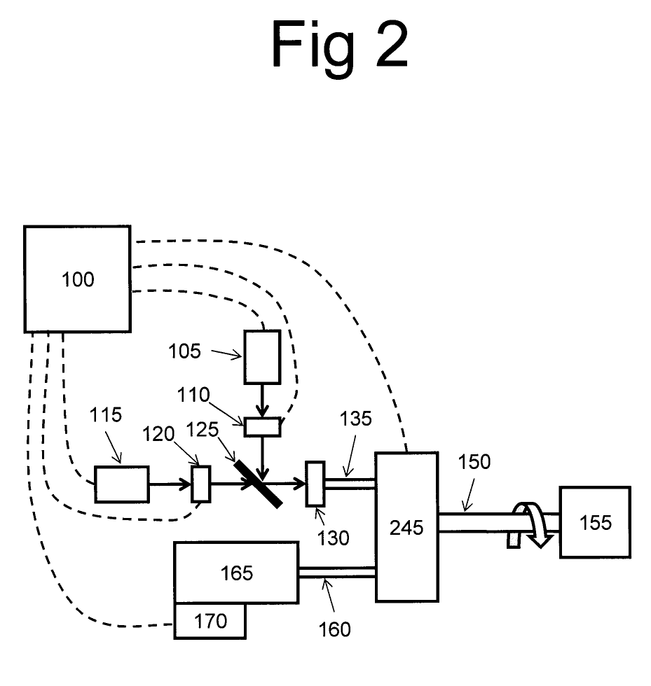

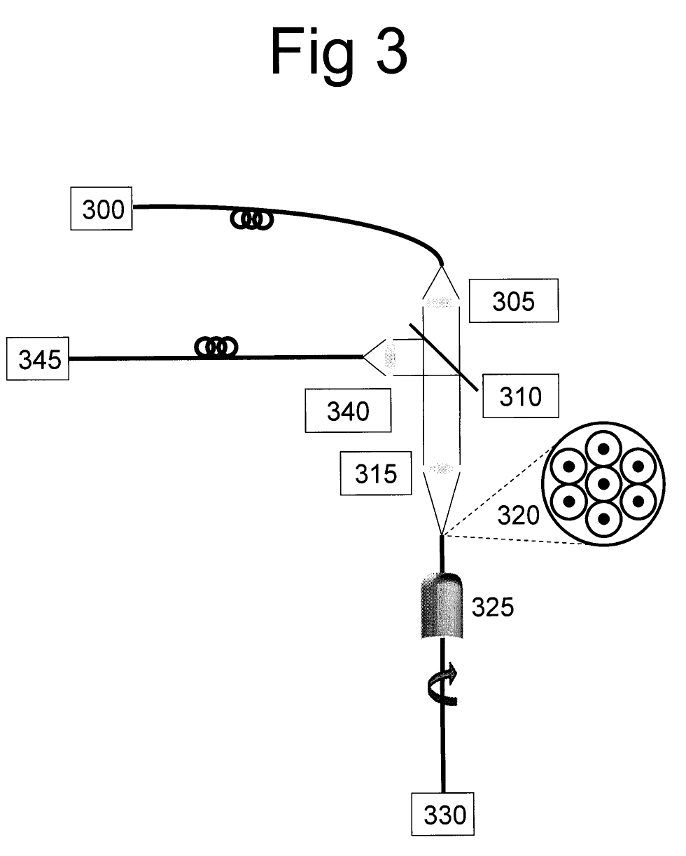

FIG. 2. shows a block diagram of an exemplary embodiment of a measurement system/device which measures Raman spectrum circumferentially over an arterial wall. This exemplary embodiment of the system/device differs from the exemplary embodiment shown in FIG. 1 and described above by a replacement of the pullback device 140 of FIG. 1 with a rotary junction 245. One of the purposes of the Raman optical rotary junction can be to couple a static fiber apparatus 250 to a rotating apparatus. The rotary junction 245 can utilize a double-passed, single-fiber coupling configuration (e.g., see exemplary embodiment shown in FIG. 3).

The rotary junction 245 can transmit the signal 150 returned from the sample 155 through the outer fibers of the bundle. In an another exemplary embodiment, a dual clad fiber can be utilized where delivery of the illumination to the tissue is through the innermost core and collection of re-emitted light is through the outer core. One exemplary way to optimize the light collection from the rotating bundle of a dual clad fiber can be to separate the illumination from the collection paths (as shown in the exemplary embodiment of FIG. 3), and focus the returned light to a waveguide that can be matched to the spectrometer's entry port slit. Connectors can be custom-fabricated to facilitate a simple and rapid connectorization of the catheter to the rotary junction.

In particular, FIG. 3 shows a block diagram of an exemplary embodiment of a measurement system/device which facilitates a circumferential scanning by utilizing a rotary junction 325 and a multiple or dual core optical fiber for illumination and collection of light. For example, an illumination light from source or sources 300 can be delivered to the system through illumination coupling optics 305. Multiple sources of the illumination light may be coupled through the illumination coupling optics 305. The illumination light(s) can then be filtered through an optical filter 310 which can transmit the illumination light, and likely rejects any background light of longer wavelengths that may have been generated and transmitted by the illumination coupling optics 305. The optical filter 310 can also be designed to reflect the Stokes-shifted remitted light, which may be at a longer wavelength than the illumination light, for delivery to the detection system.

As shown in FIG. 3, after passing the optical filter 310, the illumination light is coupled, via coupling optics 315, to an optical delivery system 320, which may consist of an optical fiber bundle or a dual-core optical fiber with side-viewing optics to interrogate luminal organs. For the fiber bundle, light will be coupled to the central fiber, whereas for the dual-core fiber, light will be coupled to the innermost core. The multiple fiber assembly will then be passed through a rotary junction 325 to provide circumferential scanning. Remitted light will be collected through the optical delivery system 320, passed through the illumination coupling optics 315, and reflected by the optical filter 310 for coupling into the detection system 345 via the collection transfer optics 340.

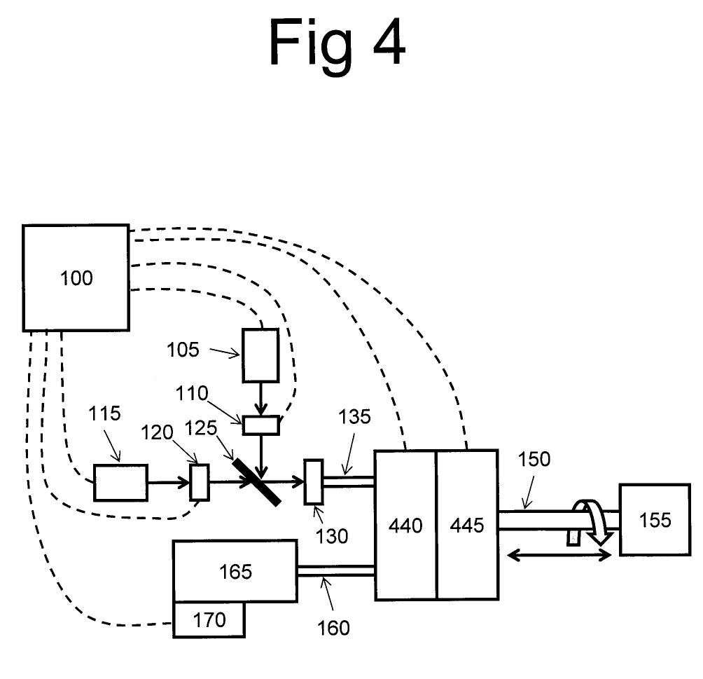

FIG. 4 shows a block diagram of another exemplary embodiment exemplary embodiment of a measurement system/device. This exemplary embodiment can facilitate a helical scanning of coronary or other arterial vessels by utilizing a rotary junction 445 in conjunction with a linear pullback device 440. Such exemplary embodiment can facilitate an acquisition of biochemical maps of entire coronary segments by both rotating and pulling back the inner core of the catheter. The rotary junction can be designed to fit within exemplary pull back devices.

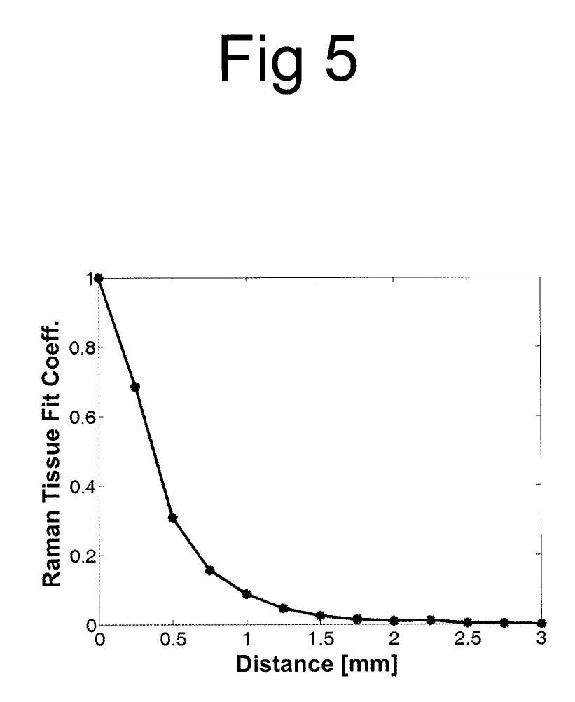

Further, the Raman signal collected by a non-contact catheter can be significantly attenuated when attempting to obtain data through whole blood (see exemplary graph of FIG. 5). To obtain a high quality spectra, it may be preferable to remove the blood from the artery lumen by use of a saline purge, e.g., by utilizing saline flushing to remove blood from coronary arteries for clear optical imaging. For a saline injection, it is possible to utilize standard, FDA-approved devices that have been previously used for this purpose. For example, an optical frequency domain interferometry (OFDI) imaging system can be used with an automatic saline infusion pump—e.g., with 30 cc of saline, perfused at a rate of 3 cc/s, can safely facilitate a clear viewing, e.g., for a duration of about 10 seconds. This can indicate that the saline perfusion paradigm can also work for circumferential intracoronary Raman spectroscopy, and, in combination with an automatic infusion pump, a pullback device, and/or a rotation device, may facilitate a chemical and molecular screening of coronary artery segments.

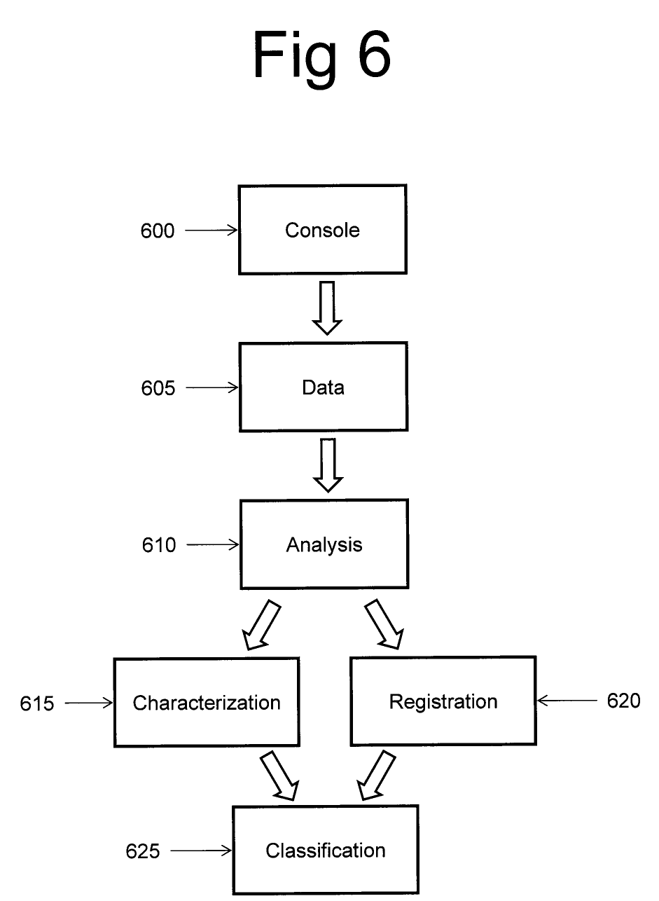

FIG. 6 shows a flow/functional diagram of an exemplary embodiment a method according to the present invention which can utilize an intracoronary Raman mapping system according to an exemplary embodiment of the present invention. For example, a console 600 (as has been described herein) can be provides which and may include the components of any of the exemplary embodiments shown in FIGS. 1-4 and described herein. For example, the console 600 can be integrated into a portable, medical-grade cart. Software can be provided on a computer-accessible medium (e.g., hard drive, CD-ROM, RAM, ROM, memory stick, floppy disk, etc.) to control and receive data 605 from the electrical and mechanical components. Further, the console can implement the analysis procedure 610, and provide a user interface for visualizing and/or characterization of the spectral maps 615 associated with chemical/molecular information in real-time.

The console 600 may be used to acquire both system calibration data and Raman scan data 605 from arterial segments. Spectral calibration data can be used for both chemometric methods and transferability of spectral data between different Raman systems. (See, e.g., Mann C K and Vickers T J. The Quest for Accuracy in Raman Specta. 2001; 251-74). Wavelength calibration standards may include emission spectra from a neon light source and Raman spectra from known wavenumber standards such as cyclohexane and acetaminophen. A calibrated intensity source can be used to correct the spectral response of the spectrometer and the CCD, and to reduce the fixed patterned noise due to the pixel-to-pixel variation. An exemplary embodiment of such source can be a NIST traceable white light source. Additional exemplary calibration procedures, including spectral acquisition from transparent and scattering chemical standards, may be implemented to normalize data acquired using different catheters and systems.

The data analysis procedure 610 can include both preprocessing and analysis of the preprocessed data. For example, the preprocessing procedures may include wavenumber calibration using the calibration data and background removal. The acquired tissue spectrum may contain sharp Raman features imposed upon a broad tissue fluorescence and probe fiber background. Through improvements in filter technology (e.g., patterning of substrate and increased extinction), contributions of the probe background to the overall spectrum can be reduced; indeed, it is possible that the tissue background may not be completely removed, e.g., likely minimized. Accurate removal of this background can be important for quantitative measurements. (See, e.g., Schulze G, Jirasek A, Yu M M, Lim A, Turner R F and Blades M W. Investigation of selected baseline removal techniques as candidates for automated implementation. Appl Spectrosc 2005; 59:545-74). The exemplary technique can be based on a polynomial subtraction method. (See, e.g., Lieber C A and Mahadevan-Jansen A. Automated method for subtraction of fluorescence from biological Raman spectra. Appl Spectrosc 2003; 57:1363-7). Other exemplary preprocessing procedures, such as wavelets to eliminate fluorescence background and reduce spectral noise, can be utilized. (See, e.g., Camerlingo C, Zenone F, Gaeta G M, Riccio R and Lepore M. Wavelet data processing of micro-Raman spectra of biological samples. Measurement Science & Technology 2006; 17:298-303).

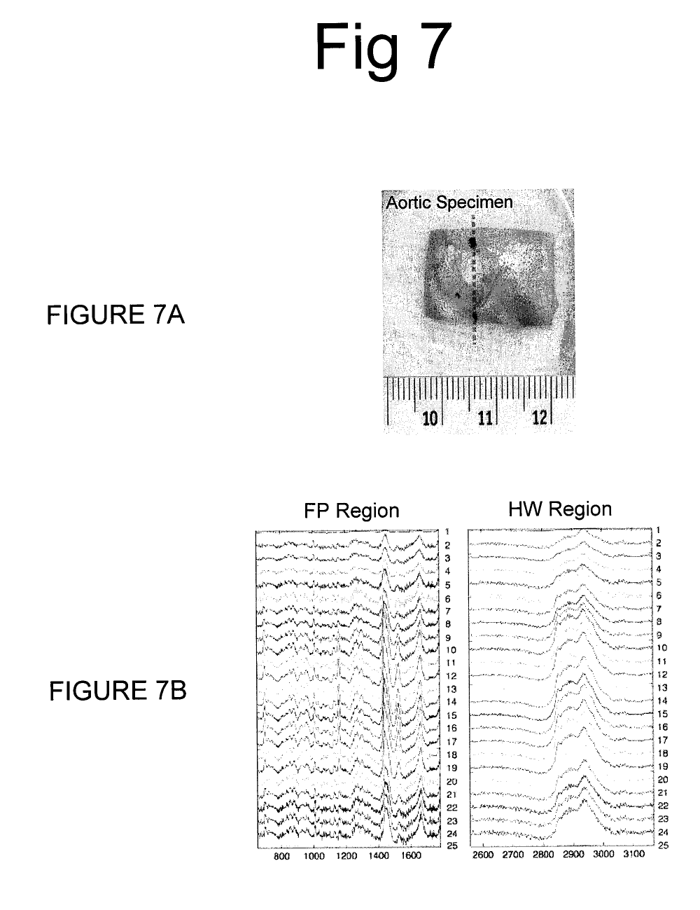

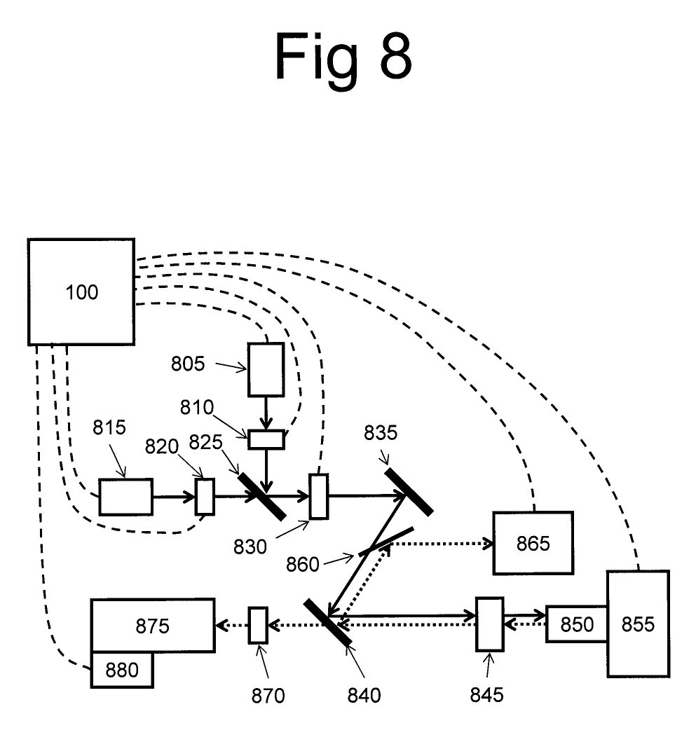

An image of an exemplary result of a Raman spectra collected during a scan of an aortic plaque ex vivo is shown in FIG. 7A. Fingerprint and high wavenumber Raman spectra (see exemplary graph of FIG. 7B) can be acquired with a preferred embodiment of benchtop Raman scanning system (see exemplary block diagram in FIG. 8). For example, a registration of the measurement sites to histological section may be accomplished by placing tissue marking ink near the end points of the linear scan. In an exemplary embodiment, the scan line can be located by illuminating the ink with the light source to create a small burn. A visual inspection of the processed spectral data (as shown in FIG. 7B) can indicate differences in both the fingerprint and high wavenumber regions. These spectral differences may correspond to differences in a chemical composition. Under a conventional single measurement site paradigm, a single Raman spectrum may have been acquired at one of the intermediate locations, which may likely have presented an incomplete characterization of the lesion.

FIG. 8 shows a block diagram of an exemplary embodiment of a measurement system/device according to the present invention which can provide a linear scanning of samples, e.g., placed on a benchtop. The illumination portion of the setup is similar to the exemplary console system, and may include two narrow-bandwidth light sources (805,815), whose illumination paths can be shuttered by shutters 810 and 820. A dichroic filter 825 may direct light from each source through appropriate bandpass filters 830 to a mirror 835 for a deflection to a dichroic filter 840 through beamsplitter 860. The dichroic filter 840 reflects the illumination light to illumination and collection optics 845 which focuses the light to sample 850.

A sample 850 can be mounted on a 3-axis translation stage 855 which can facilitate the scanning of the sample 850 under the focused illumination light. The translation stage 855 may or may not be coupled with a temperature controlled bath capable of maintaining samples at body or other temperatures. The remitted light from the sample can then be collected by the illumination/collection optics 845 and collimated to pass through dichroic filter 840. The remitted light can then be coupled to spectrometer 875 with coupling optics 870, and then dispersed onto a detector 880, such as a CCD or another array detector. A computer 800 can be used to control the illumination sources 805, 815, shutters 810, 820, a bandpass filter switching mechanism 830, a sample stage 855, and a detector 855. In addition, a small portion of the remitted light may be transmitted back through the beamsplitter 860 and deflected to a detector 865. The intensity of the light impinging upon detector 865 can be used to determine the optimal focusing of the illumination light through a computer controlled feedback loop which may utilize sample stage 855 to vary the spacing between the illumination/collection optics 845 and the sample 850.

The preprocessed spectral data may be further analyzed to reduce the dimension of the data 510. The data can be represented by a set of basis vectors using any data fitting algorithm. Basis vectors may be chemical, morphological, or numerical. In a preferred embodiment, weighting coefficients may be found using a fitting algorithm, such as ordinary least squares (OLS), and/or if they are orthogonal, by determining the dot product of each basis with the data. For chemical and molecular components, the weighting coefficients can be normalized by an estimated Raman scattering cross-section.

The weighting coefficients from the reduced data set may be used for characterization of the Raman spectra 615 of FIG. 6. The exemplary characterization may include determining chemical composition, calculating ratiometric and semi-quantitative measurements, and/or calculating other characterization metrics. Ratios and percentages may be advantageous because they are self-referenced; factors such as fluorescence, optical properties, thrombus, and blood may partially cancel. Ratiometric measurements can be determined by dividing individual weighting coefficients (i.e. lipid/collagen, etc.). Semi-quantitative measurements can be determined by ascertaining the ratio of any given weighting coefficient to the sum of all weights.

One exemplary embodiment can utilize physical models since they can provide information directly related to chemical, molecular, and morphologic properties. An alternative exemplary embodiment can implement statistical data reduction methods, e.g., principal components analysis (PCA) or wavelets, to form a set of numerically derived basis vectors.

The ability to obtain reliable ratiometric and semi-quantitative chemical/molecular measurements from coronary arteries can be very useful. Since an exemplary method for extracting concentrations may provide additional information, it is possible to utilize the exemplary analysis to obtain more quantitative results. An exemplary approach to this problem can be, e.g., to compare hybrid Monte Carlo-Zemax simulations to the measured Raman spectra, using a least squares minimization technique. Inputs to the model may include, but not limited to: a) basis spectra, b) Raman scattering cross-sections, c) weighting coefficients, d) optical properties, and e) distance from the catheter to the arterial wall.

It may be possible to assume that the weighting coefficients can be determined from the measurements and it may be possible to determine the basis spectra and estimate the Raman scattering cross-sections from ex vivo homogenized tissue and confocal microscopy studies. A library of plaque optical properties can be created from human arterial tissue, using a double-integrating sphere, inverse adding-doubling method (see, e.g., Prahl S A. The adding-doubling method. In Optical-Thermal Response of Laser Irradiated Tissue. Plenum Press, New York, N.Y. 1995; 101-29) or diffuse reflectance spectrophotometry (see, e.g., Kienle A, Lilge L, Patterson M S, Hibst R, Steiner R and Wilson B C. Spatially resolved absolute diffuse reflectance measurements for noninvasive determination of the optical scattering and absorption coefficients of biological tissue. Applied Optics 1996; 35:2304-14). This exemplary library can be utilized as initial conditions. Catheter-arterial wall distance can be measured to develop the model, but for clinical use, this parameter can be variable. Recognizing that this is an extremely challenging problem that may be ill-posed, it is possible to test the exemplary method in non-scattering chemical solutions and then on homogeneously scattering chemical phantoms. Convergence can be evaluated, as a function of the number of unknowns, the initial conditions, and a priori information. If the exemplary model converges to accurate solutions for homogenous phantoms, it is possible to then test the method in mortarized tissue mixtures and human cadaver arteries.

It is also possible to provide optical simulation techniques to determine Raman sampling volumes. An exemplary embodiment can utilize hybrid Monte Carlo-Zemax simulation code that can model the catheter excitation and detection geometry as well as the excitation of Raman scattering and the propagation of Stokes-shifted photons through tissue. The simulation method can encompass the following exemplary general procedures: a) forward propagation of the excitation photons into the tissue, b) simulation of isotropic Raman scattering, and c) propagation back to the catheter at the Stokes shifted wavelength. For illumination, the excitation photon distribution input to the Raman Monte Carlo simulation may be computed using ray tracing from any optical software model of the exemplary catheter. While Zemax can be used in this exemplary embodiment, alternative software packages, whether commercial or custom written, may also be suitable. For the detection, the remitted Raman scattered photons generated by the Raman Monte Carlo code can be ray traced back to the Zemax model of the catheter.

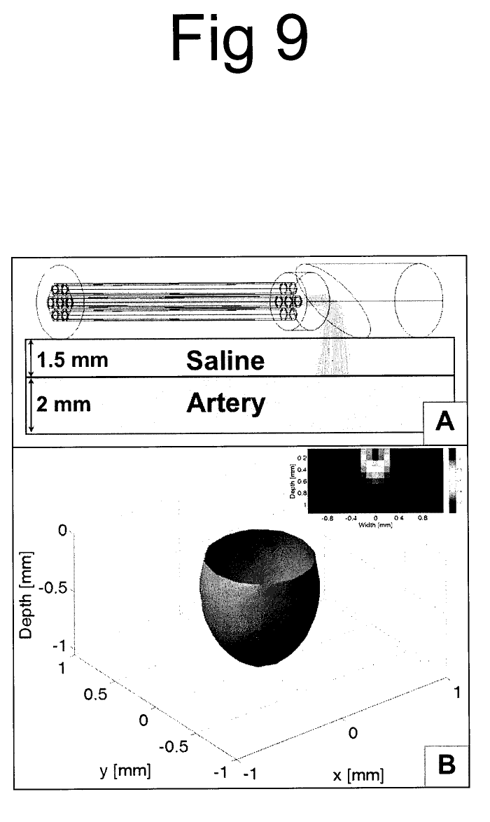

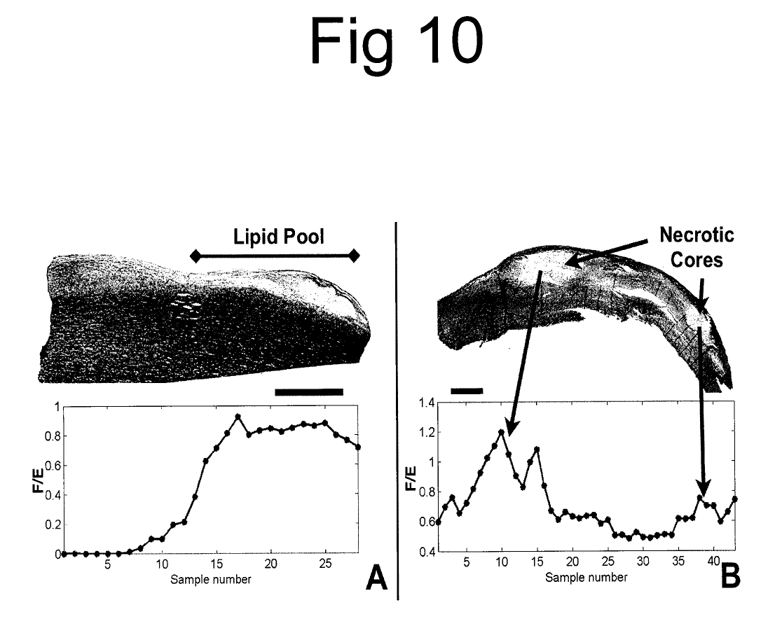

FIG. 9A shows a schematic illustration of an exemplary simulation geometry, which can comprise an exemplary Raman catheter, e.g., over a 1.5 mm thick semi-infinite layer of saline and a simulated artery. The optical properties of the artery (e.g., μₐ=1 cm⁻¹, μₛ=200 cm⁻¹, g=0.9, n=1.4) may be estimated from published values. Scattering angles can be modeled using the Henyey-Greenstein phase function. Exemplary results from a 1,000,000-photon simulation showed that 80% of the collected Raman scattered light emanated from a volume of approximately 0.8×0.8×1.0 mm (see exemplary graph in FIG. 9B). An overall Raman collection efficiency (#photons collected divided by #photons generated and remitted at tissue surface) for this catheter can be determined to be, e.g., 0.12%. While this exemplary result can be different for other catheter designs, this data indicates that a computational model can be provided for determining Raman scattering distributions and Raman collection efficiency for any given catheter configuration.

One exemplary factor affecting quantitative concentration measurements can be the distance between the catheter and the artery wall. One method to estimate this distance is to add a known concentration of an FDA-approved substance such as lactate to the saline (e.g. Lactated Ringer's solution). Lactate has a distinct peak at 856 cm⁻¹ and may not have significant overlap with biochemicals generally observed in tissue. A measurement of the weighting coefficient for lactate could therefore aid in estimating the distance from the catheter to the wall, which can then be input into the Monte Carlo Method for obtaining absolute concentration information. Another exemplary advantage of utilizing a lactate solution may be that it affords an internal calibration of the catheter and system.

Indeed, FIGS. 9A and 9B show an exemplary result of a calculated ratiometric quantity. In n exemplary embodiment, the free cholesterol to cholesterol ester (F/E) ratio may be determined at each measurement site. Raman spectral maps may be obtained by scanning cadaver aortic specimens, as indicated by the exemplary embodiment shown in FIG. 8. For example, F/E ratio profiles may then be correlated with histology or other imaging modalities. FIG. 9A and FIG. 9B show exemplary results for a non-necrotic lipid pool (see FIG. 9A) and a necrotic core fibroatheroma (see FIG. 9B). F/E ratios may increase over the lipid containing regions. In addition, the F/E ratio appears to be higher for the larger necrotic core (see FIG. 9B) than for the non-necrotic lipid pool (see FIG. 9A). Certain factors may be considered when interpreting these F/E ratios, including the necrotic core size, cap thickness, and Raman sampling volume. Indeed, these exemplary results can indicate that F/E ratios may be measured accurately and plaque measurements of F/E correspond well to histopathologic observations.

One exemplary goal of the registration process 620 of FIG. 6 can be to co-register, e.g., Raman maps, OFDI, IVUS and angiographic images. For each coronary site, the location of the Raman catheter can be documented by digital angiography prior to data acquisition. Computer controlled, constant velocity pullback OFDI or IVUS imaging can facilitate a determination of the longitudinal position of the imaging catheter with respect to the Raman spectroscopy sites. Landmarks including the distal end of the guiding catheter, stent edges and major side-branch vessels can be used to further improve registration accuracy. Previously, a registration accuracy of 0.5±0.2 mm can be achieved with such exemplary technique. Corresponding Raman maps, OFDI images, IVUS images and angiogram frames can be extracted for direct comparison. Circumferential co-registration of individual Raman maps and OFDI images can be accomplished by registering digital counter values on each rotary junction's motor encoder.

An exemplary embodiment of the registration process 620 in living human patient may be accomplished. The culprit lesion can be determined by the patient's angiogram. (See, e.g., Ambrose J A, Winters S L, Arora R R, Haft J I, Goldstein J, Rentrop K P, Gorlin R and Fuster V. Coronary angiographic morphology in myocardial infarction: a link between the pathogenesis of unstable angina and myocardial infarction. J Am Coll Cardiol 1985; 6:1233-8). For example, a 7F guide catheter can be advanced to the coronary ostium. OFDI (e.g., 100 fps) can be performed by advancing the OFDI catheter through the guide catheter and over a 0.14″ guide wire to a location that is distal to the culprit lesion. During a continuous 3 cc/s saline injection (Medrad Avanta) through the guide catheter, the OFDI catheter's inner core can be withdrawn at a constant rate of 10 mm/s. After OFDI, culprit and remote lesions proximal to the culprit plaque can be investigated with Raman. The Raman catheter can be advanced over the guide wire to the following coronary sites: 1) distal, mid, and proximal culprit lesion and 2) distal, mid, and proximal remote lesion.

For each site, a spectral acquisition can be conducted in conjunction with a 10 cc manual saline purge or by using the saline injector with a flow rate of 3 cc/s for up to 10 seconds. An exemplary Raman catheter rotational rate can be, e.g., 0.5 Hz, and the spectra can be acquired at 5/s. These exemplary parameters can result in a circumferential sampling spacing of approximately 1.0 mm, which matches the Raman sampling area (see FIGS. 9A and 9B). A digital coronary angiography can be conducted at the start and end of the OFDI pullback and before and after Raman data acquisition for each site. Angiograms will additionally be used to evaluate safety.

A coronary motion is known to move catheters in the transverse and longitudinal planes of the artery. Longitudinal motion artifacts, which commonly occur in the right coronary and left circumflex arteries, may be problematic when conducting high-resolution imaging. Longitudinal and circumferential motion primarily can occur during a systolic contraction. In the exemplary case, EKG gating may be used to avoid collecting data during this portion of the cardiac if motion becomes problematic.

It is possible to utilize Raman to classify plaque type 625, so as to place this information into the context of the histopathologic diagnosis. Such exemplary embodiment can follow the same or similar overall classification methods as that conducted previously, and may additionally include spectral information from the high wavenumber region.

An exemplary limitation of previous Raman-based arterial classification methods may be that the spectrum of CAD pathologies was reduced to three general diagnostic categories; normal, calcified plaque and lipid-rich plaques. Accordingly, it is possible to utilize a current plaque classification scheme, as described in Virmani et al., which includes normal artery, intimal hyperplasia, intimal xanthoma, pathologic intimal thickening, fibrocalcific lesion, necrotic core fibroatheroma (NCFA), and TCFA. (See, e.g., Virmani R, Kolodgie F D, Burke A P, Farb A and Schwartz S M. Lessons from sudden coronary death: a comprehensive morphological classification scheme for atherosclerotic lesions. Arterioscler Thromb Vasc Biol 2000; 20:1262-75.). It is also possible to additionally employ IHC to make a diagnosis of PG/GAG-rich plaque. Basis spectra from chemical, molecular, or morphological components can be derived. Numerically derived basis spectra can also be used. Plaque type can be determined by inputting the weighting coefficients into a classification algorithm, e.g. logistic regression.

For example, sampling points that have a SNR above the threshold can be analyzed. Areas containing thrombus, determined by spectral identification of significant thrombus signature and presence of thrombus on co-registered OFDI images, can be excluded from the exemplary analysis. In an exemplary embodiment, plaque type classification can be conducted at each arterial sampling point using the following exemplary categories: 1) thin-capped fibroatheroma (TCFA), 2) necrotic core fibroatheroma (NCFA), 3) pathologic intimal thickening, 4) fibrocalcific nodule, 5) intimal hyperplasia, and 6) xanthoma. The capability of plaque diagnosis for predicting patient presentation can be determined by receiver operator characteristic (ROC) curve analysis. In addition, normalized TCFA and NCFA surface areas and percentages of patients with TCFA or NCFA classifications can be compared to patient presentation using chi-squared or Fisher exact test. Chemical measurements including, but not limited to the F/E ratio, collagen/lipid ratio, hyaluronan, collagen, and cholesterol, can be extracted from the spectral data. Statistical metrics, such as the mean and sum (normalized to the to lumen surface area), of the chemical measurements can be computed. These exemplary statistical metrics can be compared for the SAP and ACS cohorts using one- and two-sided t-tests. A p-value <0.05 can be considered statistically significant.

The inclusion of OFDI according to the exemplary embodiment of the present invention can provide certain possibilities. For instance, OFDI can be utilized as a standard to validate the accuracy of intracoronary Raman for plaque characterization. In addition, instead of guiding the Raman spectral collection locations by angiography, these sites can be selected by the analysis of the OFDI images. This option may facilitate the identification of suspicious information by OFDI followed by a more detailed review at the molecular composition with Raman. Additionally, the exemplary OFDI images can provide a priori information that can facilitate an extraction of a quantitative concentration information, through a Monte Carlo minimization procedure. Implementation of this exemplary approach can provide important information about the feasibility and utility of a combined OFDI-Raman device.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with any OCT system, OFDI system, spectral domain OCT (SD-OCT) system or other imaging systems, and for example with those described in International Patent Application PCT/US2004/029148, filed Sep. 8, 2004, U.S. patent application Ser. No. 11/266,779, filed Nov. 2, 2005, and U.S. patent application Ser. No. 10/501,276, filed Jul. 9, 2004, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. An apparatus for controlling at least one electro-magnetic radiation, comprising:
a particular arrangement which is configured to at least one of rotate or translate at least one optical waveguide, wherein at least one of the at least one optical waveguide receives a first radiation at a first wavelength and transmits the first radiation to at least one sample, wherein the at least one or another one of the at least one optical waveguide receives a second radiation at a second wavelength that is different from the first wavelength, and wherein the second radiation is produced based on an inelastic scattering of the first radiation.

2. The apparatus according to claim 1, further comprising:
a processing arrangement configured to receive data associated with the second radiation, and determine at least one characteristic of the at least one sample based on the data.

3. The apparatus according to claim 2, wherein the processing arrangement generates at least one image or at least one map of at least one portion of the at least one sample based on the at least one characteristic.

4. The apparatus according to claim 3, wherein the at least one characteristic is a chemical characteristic.

5. The apparatus according to claim 3, wherein the at least one of the image or the map includes a ratio of different chemical characteristics.

6. The apparatus according to claim 1, wherein the at least one waveguide includes at least one fiber.

7. The apparatus according to claim 6, wherein the at least one fiber includes a plurality of fibers or a fiber bundle.

8. The apparatus according to claim 7, wherein one of the fibers receives the first radiation, and at least another one of the fibers receives the second radiation.

9. The apparatus according to claim 7, wherein a particular fiber of the fibers receives the first and second radiations.

10. The apparatus according to claim 1, further comprising a spectral separating arrangement which is configured to transmit the first radiation to the at least one waveguide, and reflect the second radiation.

11. The apparatus according to claim 10, wherein the spectral separating arrangement is at least one of a spatial filter, a dichroic mirror, a grating or a prism.

12. The apparatus according to claim 1, further comprising a spectral separating arrangement which is configure to reflect the first radiation to the at least one waveguide, and transmit the second radiation.

13. The apparatus according to claim 12, wherein the spectral separating arrangement is at least one of a spatial filter, a dichroic mirror, a grating or a prism.

14. An apparatus for generate at least one image or at least one map of at least one portion of at least one arterial sample, comprising:
a first arrangement receives a first radiation at a first wavelength, transmits the first radiation to the at least one arterial sample, and receives a second radiation at a second wavelength that is different from the first wavelength, wherein the second radiation is produced based on an inelastic scattering of the first radiation, and wherein the first radiation illuminates at least one luminal aspect of the at least one portion; and
a second processing arrangement configured to receive data associated with the second radiation, determine at least one characteristic of the at least one sample based on the data, and generate the at least one image or the at least one map of the at least one portion of the at least one arterial sample based on the at least one characteristic.

15. The apparatus according to claim 14, wherein the at least one characteristic is a chemical characteristic.

16. The apparatus according to claim 14, wherein the at least one of the image or the map includes a ratio of different chemical characteristics.

17. The apparatus according to claim 14, wherein the at least one arterial sample includes a coronary artery.

18. The apparatus according to claim 14, wherein the at least one arterial sample is in-vivo.

19. Computer accessible medium which includes a software arrangement thereon, wherein, when a processing arrangement executes the software arrangement, the processing arrangement is configured to modify at least one characteristic of an arrangement using procedures comprising:
simulating at least one electro-magnetic radiation provided into and out of the arrangement;
simulating an inelastic scattering radiation from at least one simulated sample;
receiving the simulated inelastic scattering radiation into and out of the simulated arrangement;
determining a simulated characteristic of the simulated arrangement as a function of the simulated inelastic scattering radiation.

20. The computer accessible medium according to claim 19, wherein the simulation of the inelastic scattering radiation is performed using at least one of a Monte-Carlo technique or a ray-tracing procedure.

21. The computer accessible medium according to claim 19, wherein the simulation of the at least one electro-magnetic radiation is performed using at least one of a Monte-Carlo technique or a ray-tracing procedure.

22. The computer accessible medium according to claim 19, wherein the simulated arrangement is a catheter.

23. The computer accessible medium according to claim 19, wherein the at least one simulated sample is at least one of an anatomical structure or a fluid.

24. The computer accessible medium according to claim 19, wherein the anatomical structure is an artery.

25. The computer accessible medium according to claim 19, wherein the fluid is blood or a transparent fluid.

26. The computer accessible medium according to claim 19, wherein the processing arrangement is further configured to modify the simulated arrangement so as to change the characteristic.

27. The computer accessible medium according to claim 19, wherein the processing arrangement is further configured to compare the simulated characteristic with an actual characteristic of an actual arrangement, and determine a further characteristic of an actual sample based on the comparison.

28. The computer accessible medium according to claim 26, wherein the comparison is performed using a least squared minimization technique.
